(19) United States
(12) Patent Application Publication
(10) Pub. No.: US 2009/0011729 A1
(43) Pub. Date: Jan. 8, 2009

(54) FM TRANSMITTER

(75) Inventors: Takeshi Ikeda, Niigata (JP); Akira Okamoto, Niigata (JP); Hiroshi Miyagi, Niigata (JP)

Correspondence Address: PATENTTM.US, P. O. BOX 82788, PORTLAND, OR, 97282-0788, US

(73) Assignees: NIIGATA SEIMITSU CO., LTD., Joetsu-shi, Niigata (JP); RICOH COMPANY, LTD., Ohta-ku, Tokyo (JP)

(21) Appl. No.: 12/279,050

(22) PCT Filed: Mar. 2, 2006
(86) PCT No.: PCT/JP2006/303941

§ 371 Date: Aug. 11, 2008

(51) Int. Cl. H04B 1/04

(52) U.S. Cl. 455/127.1

(57) ABSTRACT

An FM transmitter which can be easily connected to an existing computer or the like and does not need any troublesome operation is provided. An FM transmitter 100 has an USB device function which can be connected to a PC 400 as an USB host device and comprises a power supply circuit 130 which is connected to the power supply pin of an USB socket 410 to generate a predetermined operating voltage when an USB plug 110 is connected to the USB socket 410 of the PC 400, an USB controller 120 for requesting that its own apparatus being a device audio source inputs/outputs data by isochronous transfer in a configuration performed by the PC 400 and a transmission processing section 140 which is actuated by the operating voltage supplied by the power supply circuit 130 and applies FM-modulation to audio data outputted from the PC 400 via the USB socket 410 for transmission.

### TECHNICAL FIELD

The present invention relates to an FM transmitter which is connected to a personal computer and the like, and FM-modulates and transmits the sound therefrom.

### BACKGROUND ART

A system is conventionally known, in which an FM transmitter is incorporated in a computer and an output audio signal of the computer is FM-modulated and transmitted (for example, see Patent Document 1). In this system, an audio signal transmitted by the FM transmitter is received by an FM radio and can be audio-outputted, which eliminates need for cable installation from the computer to a speaker or an external audio device.

Patent Document 1: Japanese Patent Laid-Open No. 2002-100997 (pp. 3-5, FIGS. 1 to 6)

In the Patent Document 1, the system configuration cannot be applied to a conventional computer not having an incorporated FM transmitter since it is presupposed that the FM transmitter should be incorporated in the disclosed system. Further, in general, the computer is provided with an audio output terminal so as to be connectable with an external speaker and the like, and if this audio output terminal is connected with the FM transmitter, the output audio signal of the computer can be FM-modulated and transmitted, similarly to the system disclosed in the Patent Document 1. However, in case where an external FM transmitter is used, the FM transmitter needs to be powered up and down each time it is connected to or disconnected from the computer, and there arises a problem of troublesome operation thereof.

The present invention has been made in view of the problem, and an object of the invention is to provide an FM transmitter capable of being easily connected to the existing computer and the like and eliminating the troublesome operation.

### DISCLOSURE OF THE INVENTION

To solve the problem, the FM transmitter of the present invention has an USB device function connectable to an USB (Universal Serial Bus) host device, and includes a power supply circuit connected to a power supply pin of an USB socket of the USB host device and adapted to generate a predetermined operating voltage when an USB plug is connected to the USB socket, an USB controller adapted to make a request that its own apparatus being a device audio source inputs/outputs data by isochronous transfer in a configuration performed by the USB host device, and a transmission processing section enabled by an operating voltage supplied from the power supply circuit and adapted to FM-modulate and output audio data outputted from the USB host device through the USB socket. The connection of the FM transmitter is facilitated because it can be connected only by inserting the USB plug into the USB connector. Further, when connected, the FM transmitter is recognized as an USB device sound source similarly to an USB speaker or an USB-connected audio device and the like, and audio data is inputted in the isochronous transfer and is FM-modulated and transmitted, thereby eliminating the troublesome operation after the connection. Particularly, when the FM transmitter is connected to the USB connector, the power supply circuit operates and the FM transmitter is ready for transmission. This eliminates a power switch, thereby making the operation simple. Further, the USB host device can recognize the FM transmitter as an USB device sound source, similarly to the USB speaker and the like, and has only to output the audio data, and therefore, installation of a special driver for the FM transmitter is not required, and this eliminates the special operation accompanied with the connection.

Further, the USB host device to which the USB plug is connected is preferably a personal computer. As a result, an output audio sound (for example, an audio sound outputted when an application such as an MP3 player is run) from the personal computer can be outputted without complicated cabling. Further, this outputted (transmitted) audio sound can be received by a general purpose FM receiver and can be outputted from the speaker.

Further, a CMOS process or MOS process is preferably used to form structures corresponding to the power supply circuit, the USB controller, and the transmission processing section on a semiconductor substrate. By using these processes, almost all the structures except for the parts unable to be formed on the semiconductor substrate such as a quartz crystal oscillator and the parts not adequate to be formed on the semiconductor substrate such as a capacitor large in electrostatic capacity can be formed as one chip component, thereby enabling the miniaturization and reduction of power consumption of the whole FM transmitter.

Further, the FM transmitter is provided with a secondary battery connected to and charged by the power supply circuit, and when the power supply circuit is not fed from the USB host device through the USB socket, the power supply circuit is preferably operated by the voltage applied from the secondary battery to generate the operating voltage. As a result, the FM transmitter can be separated from the USB host device and operated alone.

Further, the FM transmitter is provided with an external input terminal in addition to the USB plug, and the transmission processing section preferably FM-modulates and transmits the audio signal inputted from the external input terminal. As a result, the charging of the secondary battery is performed when connected to the USB host device, and when the connection is separated, the output audio sound from another audio device connected to the external input terminal can be FM-modulated and transmitted.

Further, the FM transmitter is provided with a secondary battery connected to and charged by the power supply circuit, and when the current required for the generation of the operating voltage is insufficient in the feeding from the USB host device through the USB socket, the power supply circuit is preferably operated by the voltage applied from the secondary battery to generate the operating voltage. As a result, even when the connected USB host device has low power supply capacity, the output audio sound can be stably transmitted. Further, when the secondary battery is charged, it has only to be connected to the USB host device with high power supply capacity, so that an external power supply for charging or the cable and the like for connecting to this external power supply is not necessary.

### BRIEF DESCRIPTION OF THE DRAWINGS

FIG. 1 is a view showing a configuration of an FM transmitter of a first embodiment;

FIG. 2 is a view showing a detailed configuration of a transmission processing section;

FIG. 3 is a view showing an operation timing of three frequency dividers;

FIG. 4 is a view showing a detailed configuration of a DSP;

FIG. 5 is a view showing a configuration of an FM transmitter of a second embodiment;

FIG. 6 is a view showing a detailed configuration of the transmission processing section of the present embodiment;

FIG. 7 is a view showing a detailed configuration of an analogue front end; and

FIG. 8 is a view showing a detailed configuration of the DSP of the present embodiment.

### DESCRIPTION OF SYMBOLS

100, 100A FM transmitters
110 USB plug
120 USB controller
130 Power supply circuit
140 Transmission processing section
400 PC (Personal Computer)
410 USB socket

### BEST MODE FOR CARRYING OUT THE INVENTION

Hereinafter, an FM transmitter of an embodiment applied with the present invention will be described in detail with reference to the drawings.

### First Embodiment

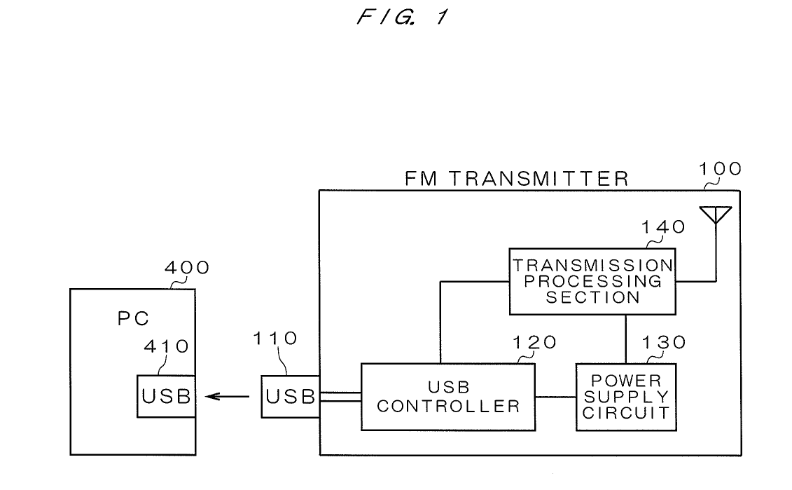

FIG. 1 is a view showing a configuration of an FM transmitter of a first embodiment. An FM transmitter 100 shown in FIG. 1 is constituted by including an USB plug 110, an USB controller 120, a power supply circuit 130, and a transmission processing section 140. The configuration corresponding to these USB controller 120, power supply circuit 130, and transmission processing section 140 (however, excepting the parts unable to be formed on the semiconductor substrate such as a quartz crystal oscillator and the parts not adequate to be formed on the semiconductor substrate such as a capacitor large in electrostatic capacitance) is formed on a semiconductor substrate as one chip component by using CMOS process or MOS process.

This FM transmitter 100 has an USB device function, and is used by directly inserting the USB plug 110 into an USB socket 410 of a PC 400. The PC 400 and the FM transmitter 100 may be connected through an extension USB cable. Further, though the USB plug 110 is mounted on a part of the housing of the FM transmitter 100 assuming that the whole of the FM transmitter 100 is mounted on the USB socket 410 of the PC 400, an USB cable is taken out from the housing of the FM transmitter 100, and its end is attached with the USB plug 110, and this USB plug 110 may be inserted into the USB socket 410 of the PC 400.

The USB controller 120, when the USB plug 110 is inserted into the USB socket 410 of the PC (Personal Computer) 400 as the USB host device, makes a request that the own device (FM transmitter 100) is a device sound source and that the input-output of the data in isochronous transfer is performed in the configuration performed with the host device. In this configuration, the PC 400 transmits a token packet to the USB controller 120, and thereby the PC 400 can learn that the FM transmitter 100 is a device sound source, and that the data transmission/reception in isochronous transfer is requested. This configuration itself is the same as the case in which another device sound source such as the USB speaker is connected.

The power supply circuit 130, when the USB socket 410 of the PC 400 is connected with the USB plug 110, is connected to a power supply pin of the USB socket 410 and generates the predetermined operating voltage. The power supply circuit 130 of the present embodiment starts generating the operating voltage by the power supply from the PC 400, and for this reason, there is no power switch provided particularly, and the FM transmitter 100 starts operating simultaneously with the connection to the PC 400.

The transmission processing section 140 can be operated by the operating voltage supplied by the power supply circuit 130, and FM-modulates and transmits the audio data outputted through the USB socket 410 of the PC 400. The audio data outputted from the PC 400 may be any data if capable of being generated in the PC 400. For an example, when an application software of an MP3 (MPEG Audio Layer-3) player or CD (Compact Disk) player is run, the audio data corresponding to these players is outputted from the PC 400. Further, when the voice data is reproduced (including the case of using the function originally provided in the operating system (OS) of the PC 400 in addition to the case of executing the dedicated application software), the audio data corresponding to the voice data is outputted from the PC 400. That is, the audio data serving as the transmission object of the FM transmitter 100 of the present embodiment includes all the audio data serving as the output object of PC 400, and includes all of music, voices, sound effects, and the like.

As described above, the FM transmitter 100 of the present embodiment can be easily connected because of the simple insertion of the USB plug 110 into the USB socket 410 of the PC 400. Further, when connected, it is recognized as the same USB device sound source as the USB speaker, the USB connected audio device, and the like, and is inputted with audio data in isochronous transfer, and this audio data is FM-modulated and transmitted, thereby making the troublesome operation after the connection unnecessary. In particular, when the FM transmitter is connected to the USB socket 410, the power supply circuit 130 is operated, so that the transmission operation by the transmission processing section 140 is made possible, and this allows the power switch to be omitted, and as a result, the operation can be simplified. Further, since the PC 400 recognizes the FM transmitter 100 as the USB device sound source similarly to the USB speaker and the like, and has only to output the audio data, there is no need to install a specific driver for the FM transmitter 100, and specific operation accompanied with the connection is made unnecessary.

Further, by using the PC 400 as the USB host device serving as the connection destination of the USB plug 110, the output audio sound (for example, the audio sound and the like outputted when an application such as an MP 3 player is run) of the PC 400 can be outputted without making complicated wiring. Further, this outputted (transmitted) audio sound can be received by a general purpose FM receiver, and can be outputted from the speaker.

Further, by using CMOS process or MOS process, structures corresponding to the USB controller 120, the power supply circuit 130, and the transmission processing section 140 are formed on the semiconductor substrate. By using these processes, almost all the structures except for the parts unable to be formed on the semiconductor substrate such as the quartz crystal oscillator and the parts not adequate to be formed on the semiconductor substrate such as a capacitor large in electrostatic capacitance can be formed as one chip, thereby enabling the miniaturization and reduction of power consumption of the whole FM transmitter.

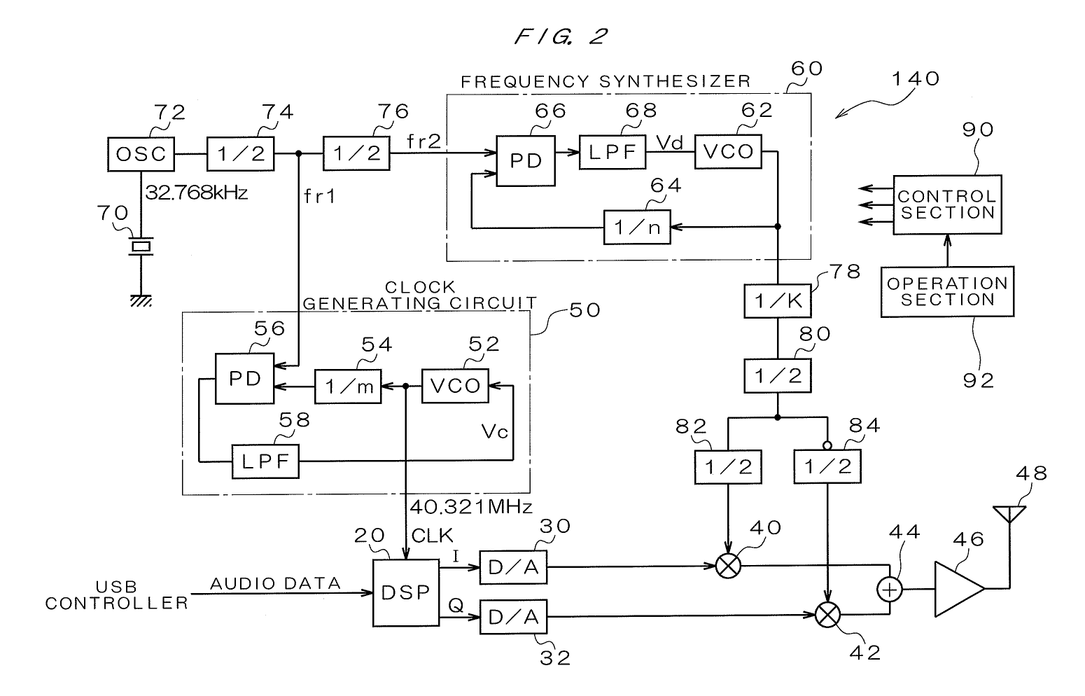

Next, a specific configuration of the transmission processing section 140 suitable for the manufacture by means of the CMOS process or the MOS process will be described. FIG. 2 is a view showing a detailed configuration of the transmission processing section 140. As shown in FIG. 2, the transmission processing section 140 of the present embodiment is provided with a DSP (digital signal processor) 20, digital-analogue converters (D/A) 30 and 32, mixers 40 and 42, an adder 44, an amplifier 46, an antenna 48, a clock generating circuit 50, a frequency synthesizer 60, a quartz crystal resonator 70, an oscillator (OSC) 72, frequency dividers 74, 76, 78, 80, 82, and 84, a control section 90, and an operation section 92.

The DSP 20, based on the output audio data of the PC 400 outputted from the USB controller 120, performs a stereo modulation processing, an FM modulation processing, and an IQ modulation processing by digital processing. From the DSP 20, I data and Q data after IQ modulation are outputted. The detail of the DSP 20 will be described later.

The digital-analogue converter 30 converts the I data outputted from the DSP 20 into an analogue I signal. Further, the digital-analogue converter 32 converts the Q data outputted from the DSP 20 into an analogue Q signal. The mixer 40 mixes and outputs an I signal outputted from one digital-analogue converter 30 and a predetermined local oscillation signal (referred to as a first local oscillation signal). The mixer 42 mixes and outputs a Q signal outputted from the other digital-analogue converter 32 and a local oscillation signal (referred to as a second local oscillation signal) 90° different in phase from the first local oscillation signal. The adder 44 synthesizes and outputs the signals outputted from two mixers 40 and 42. An output (FM modulation signal) of the adder 44 is power-amplified by an amplifier 46, and after that, is transmitted from an antenna 48.

The clock generating circuit 50 generates an operation clock signal CLK necessary for the digital processing of the DSP 20. For example, a reference frequency signal fr1 of 16.384 kHz is inputted, and a clock signal CLK which is synchronizing with this reference frequency signal of the frequency (40.321 MHz) multiplied by 2461 of this frequency is generated. To this end, the clock generating circuit 50 is provided with a voltage controlled oscillator (VCO) 52, a frequency divider (1/m) 54, a phase comparator (PD) 56, and a low pass filter (LPF) 58. The voltage controlled oscillator 52 performs an oscillation operation of the frequency corresponding to a control voltage Vc. The frequency divider 54 frequency-divides the output signal of the voltage controlled oscillator 52 by a fixed frequency dividing ratio m (2461) and outputs it. The phase comparator 56 compares phase of a frequency dividing signal outputted from the frequency divider 54 with that of the reference frequency signal fr1, and outputs a pulse signal led or lagged according to a phase difference. The low pulse filter 58 smoothes a pulse signal outputted from the phase comparator 56, and generates a control voltage Vc supplied to the voltage controlled oscillator 52. As described above, the clock generating circuit 50 has a PLL configuration (first PLL circuit), and generates a clock signal CLK having the frequency (40.321 MHz) multiplied by 2461 of the frequency of the reference frequency signal fr1, and inputs this clock signal CLK to the DSP 20.

The frequency synthesizer 60 generates an oscillation signal required to generate the first and second oscillation signals inputted to the mixers 40 and 42. For an example, a reference frequency signal fr2 of 8.192 kHz is inputted, and a signal which is synchronizing with this reference frequency signal and of the frequency multiplied by n of this frequency is generated. To this end, the frequency synthesizer 60 is provided with a voltage controlled oscillator (VCO) 62, a variable frequency divider (1/n) 64, a phase comparator (PD) 66, and a low pass filter (LPF) 68. The voltage controlled oscillator 62 performs an oscillation operation of the frequency corresponding to a control voltage Vd. The variable frequency divider 64 frequency-divides the output signal of the voltage controlled oscillator 62 by a variable frequency dividing ratio n and outputs it. The phase comparator 66 performs a phase comparison with a frequency divided signal outputted from the variable frequency divider 64 and the reference frequency signal fr2, and outputs a pulse signal of a duty ratio according to a phase difference. The low pulse filter 68 smoothes the pulse signal outputted from the phase comparator 66, and generates a control voltage Vd supplied to the voltage controlled oscillator 62. AS described above, the frequency synthesizer 60 has a PLL configuration (second PLL circuit), and generates the signal having the frequency multiplied by n of the frequency of the reference frequency signal fr2. The dividing ratio n of the variable frequency divider 64 is set by a control section 90.

The oscillator 72 is connected to the quartz crystal resonator 70, and oscillates by a natural oscillation frequency of this quartz crystal resonator 70. In the present embodiment, the quartz crystal resonator 70 has the natural oscillation frequency lower than 38 kHz. Specifically, the quartz crystal resonator 70 easily obtained at a low cost and having the natural oscillation frequency of 32.768 kHz is used. The subsequent stage of the oscillator 72 is connected in cascade with two frequency dividers 74 and 76. The frequency divider 74 of the preceding stage is set to 2 in frequency dividing ratio and frequency-divides in two the oscillation signal of 32.768 kHz outputted from the oscillator 72 and outputs it. This output signal is inputted to the frequency divider 76 of the subsequent stage, and at the same time, is inputted to the clock generating circuit 50 as the reference frequency signal fr1. The frequency divider 76 of the subsequent stage is set to 2 in frequency dividing ratio, and frequency-divides in two the output signal of the frequency divider 74 of the preceding stage and outputs it. This output signal is inputted to the frequency synthesizer 60 as the reference frequency signal fr2.

The frequency divider 78 is set to K (K is an integer 1 or more) in frequency dividing ratio, and frequency-divides the output signal of the voltage controlled oscillator 62 included in the frequency synthesizer 60 by the frequency dividing ratio K and outputs it. In the present embodiment, for ease of explanation, the frequency dividing ratio K is assumed to be set to 1. The three frequency dividers 80, 82, and 84 are set to 2 in each frequency dividing ratio, and generate a signal having ¼ of the frequency as a first local oscillation signal for the output signal of the frequency divider 78, and at the same time, generate a signal having the same frequency as this first local oscillation signal but being different 90° in phase only as a second local oscillation signal. The frequency divider 80 is used for wave shaping, and the frequency dividers 82 and 84 are used for generating the first and second local oscillation signals of which are different 90° in phase each other. Further, the frequency divider 80 is for enabling a signal of 50% in duty ratio to be reliably obtained by the frequency dividers 82 and 84. When the duty ratio of the output signals of the frequency dividers 82 and 84 is not 50%, the effect of an image frequency rejection is remarkably deteriorated, and therefore, by using the frequency divider 80, this is prevented.

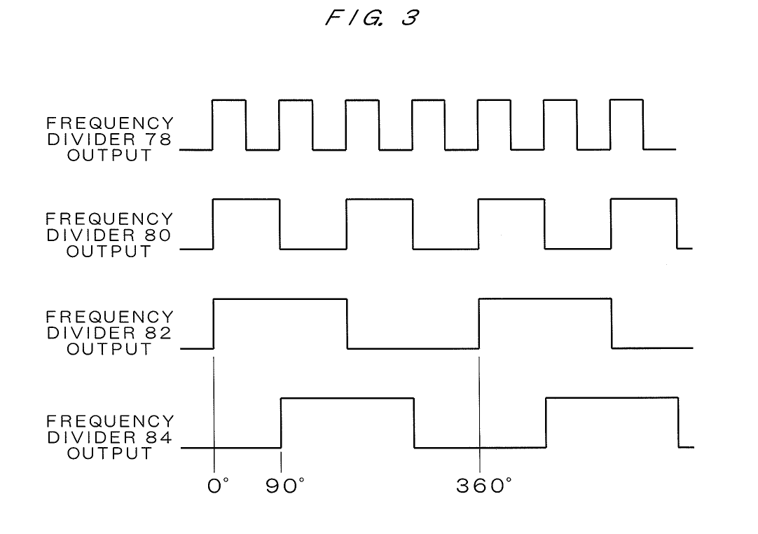

FIG. 3 is a view showing the operation timing of the three frequency dividers 80, 82, 84. As shown in FIG. 3, the frequency divider 80 frequency-divides in two the output signal of the frequency divider 78 shown by the “frequency divider 78 output” and outputs it. Further, the frequency divider 82 operates by synchronizing with a rising timing of the output signal of the frequency divider 80, and frequency-divides in two this output signal and outputs it. On the other hand, the frequency divider 84 operates by synchronizing with a falling timing of the output signal of the frequency divider 80, and frequency-divides in two this output signal and outputs it. In this manner, the first and second local oscillation signals having ¼ of the frequency for the output signal of the frequency divider 78 and being mutually different 90° in phase are generated.

The control section 90 controls the whole of the transmission processing section 140. For example, the control section 90 sets a frequency dividing ratio of a variable frequency divider 64 inside the frequency synthesizer 60, and decides a transmission frequency of the FM modulation signal. The operation section 92 is provided with various switches operated by a user. For example, a power switch, up and down keys for instructing the switching over of the transmission frequency, and the like are provided. When the transmission frequency of the FM modulation signal is fixed, the operation section 92 may be omitted. Further, by providing a display section, the transmission frequency and the operation content and the like of the operation section 92 may be displayed.

In the present embodiment, the transmission processing section 140 is integrally formed with each function of all the parts except for the quartz crystal resonator 70, the antenna 48, and the operation section 92 together with the USB controller 120 and the power supply circuit 130 on a piece of the semiconductor substrate by using a semiconductor process.

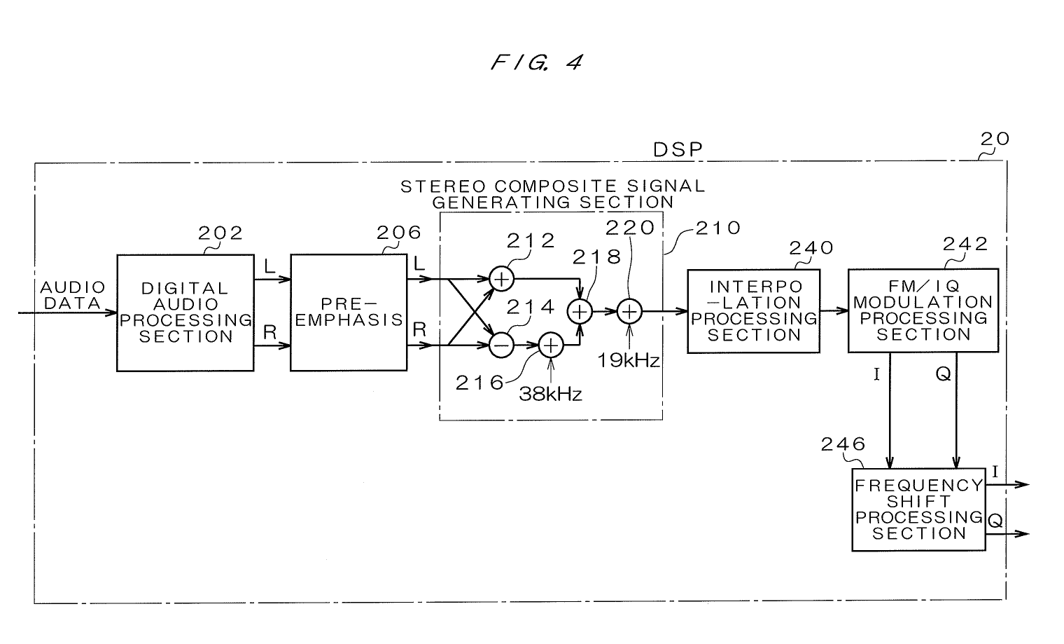

Next, the DSP 20 will be described in detail. FIG. 4 is a view showing the detail configuration of the DSP 20. As shown in FIG. 4, the DSP 20 is provided with a digital audio processing section 202, a pre-emphasis processing section 206, a stereo composite signal generating section 210, an interpolation processing section 240, an FM/IQ modulation processing section 242, and a frequency shift processing section 246. The function of each configuration of these sections is realized by the digital processing performed by the DSP 20.

The digital audio processing section 202, when inputted with the audio data of a predetermined format, extracts L data and R data contained in this audio data, and at the same time, when a sampling rate of these L data and R data is different from a predetermined rate, performs the conversion of the sampling rate. The pre-emphasis processing section 206 is used for emphasizing a modulation degree of the frequency component of each high band of the inputted L data and R data.

The stereo composite signal generating section 210 performs a stereo modulation so as to generate a stereo composite signal, and is constituted by containing addition sections 212, 216, 218, and 220 and a subtraction section 214. By the addition section 212, the L data and the R data are added, thereby to generate an (L+R) component. By the subtraction section 214, the L data is subtracted with the R data, thereby to generate an (L−R) component. The addition section 216 adds a sub-carrier signal of 38 kHz to the (L−R) component generated by the subtraction section 214. The addition section 218 generates a signal containing the (L+R) component, the (L−R) component, and the sub-carrier signal by further adding an addition result by each of the addition sections 212 and 216. To this signal, a pilot signal is added by the addition section 220, so that the stereo composite signal is generated and outputted from the stereo composite signal generating section 210.

The interpolation processing section 240 performs an interpolation processing for increasing the number of data for the stereo composite signal to be inputted. For example, fifty times over-sampling processing for generating 49 pieces of data between the two data sequentially inputted by the interpolation processing is executed. The FM/IQ modulation processing section 242 performs the FM modulation processing for the stereo composite signal after the interpolation processing, and at the same time, extracts the I component and the Q component of the data after the modulation. When the modulated data is represented in a complex number, a real part (cos component) is the I component and an imaginary part (sin component) is the Q component.

The frequency shift processing section 246 performs a frequency shift (frequency conversion) for the I data and the Q data outputted from the FM/IQ modulation processing section 242. This frequency shift processing is for the purpose of preventing wraparound of the signals in the mixers 40 and 42 provided at the subsequent stage of the DSP 20. The FM/IQ modulation processing section 242 outputs the data frequency-modulated in a base band region. Supposing that this data is directly inputted to the mixers 40 and 42, in the mixers 40 and 42, the FM-modulated signals having the same frequency as the first and second local oscillation signals outputted from each of the frequency dividers 82 and 84 are outputted. Consequently, when a so-called carrier leak occurs, in which a part of the first and second local oscillation signals sneaks to the output terminal side of the mixers 40 and 42, there occurs inconvenience that these sneaked first and second local oscillation signals are contained inside the band of the transmission signal, thereby deteriorating the quality of the transmission signal. In the present embodiment, to avoid such inconvenience, a processing for raising the frequency is performed for the data having a frequency of a base band region by the frequency shift processing section 246. Assuming that this shifted frequency is taken as an offset frequency foffset, and the frequencies of the first and second local oscillation signals are taken as fLO, the frequencies fo of the output signals of the mixers 40 and 42 become (fLO−foffset) or (fLO+foffset), and therefore, by setting the offset frequency foffset to an appropriate value, the carrier leak whose local oscillation signal leaks inside the band of the transmission signals outputted from the mixers 40 and 42 can be prevented.

The frequency synthesizer 60, the frequency dividers 78, 80, 82, and 84 correspond to a carrier wave generation circuit, the frequency divider 54 corresponds to a first frequency divider, the variable frequency divider 64 corresponds to a second frequency divider, the frequency dividers 78, 80, 82, and 84 correspond to a third frequency divider, and the mixers 40 and 42, the adder 44, and the amplifier 46 correspond to the transmission circuit, respectively.

The features of the transmission processing section 140 of the present embodiment can be cited as follows.

(1) By using the clock generating circuit 50, the clock signal of high frequency (40.321 MHz in the example shown in FIG. 2) is generated, and the digital processing by the DSP 20 is performed so as to perform the stereo modulation processing, and therefore, there is no need to generate the signal of 38 kHz as a sub-carrier or the signal of 19 kHz as a pilot signal. Hence, a degree of freedom for selecting the component (quartz crystal resonator) can be improved.

(2) The reference frequency signal fr2 having further lower frequency of 8.192 kHz is generated by frequency-dividing the output signal of the oscillator 72 low in frequency oscillation by the two frequency dividers 74 and 76. This frequency of 8.192 kHz is sufficiently low for an assigned frequency interval (100 kHz) of FM broadcast waves, and therefore, an error between a desired frequency (frequency receivable by the FM receiver) and the frequency of the actual FM transmission signal can be reduced.

(3) Since the IQ modulation system is used, the image frequency contained in the FM transmission signal can be reduced.

(4) The quartz crystal resonator 70 having an natural oscillation frequency of 32.768 kHz is commercially available for watch in low price, and therefore, can be easily obtained, and the component cost thereof can be reduced.

(5) Since the output signal of the frequency synthesizer 60 is L (=4K) frequency-divided by the frequency dividers 78, 80, 82, and 84 so as to generate the first and second local oscillation signals, it is possible to perform an oscillation frequency switching of the frequency synthesizer 60 at the frequency interval of 4K times of 100 kHz which is the assigned frequency interval of the FM broadcast waves. Hence, when the reference frequency signal fr2 of 8.192 kHz not coinciding with the assigned frequency interval or an integral fraction of the interval is used, an error between the desired frequency (frequency receivable by the FM receiver) and the frequency of the actual FM transmission signal can be further reduced. That is, as described in (2) above, though the reference frequency signal fr2 is generated by frequency-dividing the output signal of the oscillator 72 by the frequency dividers 74 and 76 so as to reduce the error, this effect becomes further marked by frequency-dividing the output signal of the frequency synthesizer 60 by the frequency dividers 78, 80, 82, and 84. For example, considering the case of K=1, although the frequency half of 8.192 kHz of the reference frequency signal fr2 becomes the maximum error, by allowing the output signal of the frequency synthesizer 60 to go through the frequency divider 80 and the like, this error can be reduced to ¼ (1.024 kHz).

Now, in general, as the reference frequency signal of the PLL frequency synthesizer, 1/n (n: an integer) of the assigned frequency interval (100 kHz in the case of Japan) of the FM broadcast waves is selected. However, when the reference frequency signal, which is not 1/n (n: an integer) of the assigned frequency interval of the FM broadcast waves as in the present embodiment, is used, a technique for reducing a shift between the frequency of the actual output signal of the PLL frequency synthesizer and the frequency of the signal desired to be transmitted is generally adopted by using the frequency divider so as to reduce the frequency as much as possible.

However, when the frequency of the reference frequency signal is reduced, a loop gain of the PLL circuit constituting the frequency synthesizer is reduced, and this creates inconvenient that a CN ratio (a ratio of the carrier level and the noise) in the vicinity of the carrier wave frequency of the FM broadcast wave is deteriorated, and at the same time, the lock time of the PLL circuit becomes long. Further, since a time constant of the low pass filter inside the PLL circuit becomes large, it becomes difficult to form the constituent parts of the whole of the frequency synthesizer on the semiconductor substrate. In contrast to this, as in the present embodiment, when the technique for generating the reference frequency signal fr2 by frequency-dividing the output signal of the oscillator 72 and the technique for frequency-dividing the output signal of the frequency synthesizer 60 are combined, various inconveniences as described above can be avoided, and at the same time, it is possible to reduce a shift (an error of the oscillation frequency) between the frequency of the local oscillation signal generated by using the frequency synthesizer 60 and the frequency of the signal desired to be transmitted. When the reference frequency signal fr2 of 8.192 kHz is used, the loop gain of the PLL circuit, the CN ratio in the vicinity of the carrier frequency of the FM broadcast wave, and the lock time of the PLL circuit are not deteriorated so much in characteristics, but the technique for frequency-dividing the output signal of the frequency synthesizer 60 can be used together to further improve these characteristics.

By using a specific numerical value, the error of the oscillation frequency will be described as follows. The frequency of the reference frequency signal fr2 inputted to the frequency synthesizer 60 from the oscillator 72 is assumed to be Fr (=8.129 kHz). Further, assuming that the oscillation frequency of the voltage controlled oscillator 62 inside the frequency synthesizer 60 is Fosc, and the frequency of the actual FM modulation signal transmitted from the amplifier 46 through the antenna 48 is Ftx, the following formula is established.

Ftx=Fr×n/(4K),

where n is a frequency dividing ratio of the variable frequency divider 64, and 4K is a frequency dividing ratio of the whole of the frequency dividers 78, 80, 82, and 84.

To obtain Ftx=90.00 MHz provided that the frequency dividers 78, 80, 82, and 84 are not available (when 4K=1 only), it is necessary to set n=Ftx/Fr=10986.328. Because the actual n is an integer, if rounded off after the decimal point, n=10986. In this case, 0.328×8.192 kHz=2.687 kHz of the fraction part (0.328) becomes a frequency error of the FM modulation signal desired to be transmitted. In contrast to this, if K=1 provided that the frequency dividers 70, 80, 82, and 84 are available, n=4K×Ftx/Fr=43945.312. When rounded off after the decimal point, n=43945. In this case, 0.639 kHz of the fraction part (0.312) becomes a frequency error of the FM modulation signal desired to be transmitted. In this manner, by inserting the frequency dividers 78, 80, 82, and 84 into the subsequent stage of the frequency synthesizer 60, the error of the transmission frequency can be reduced.

### Second Embodiment

Now, in the above described embodiment, by inserting the USB plug 110 into the USB socket 410 of the PC 400, the audio sound outputted from the PC 400 is transmitted from the FM transmitter. However, the audio sound outputted from the audio device other than the PC 400 may be transmitted.

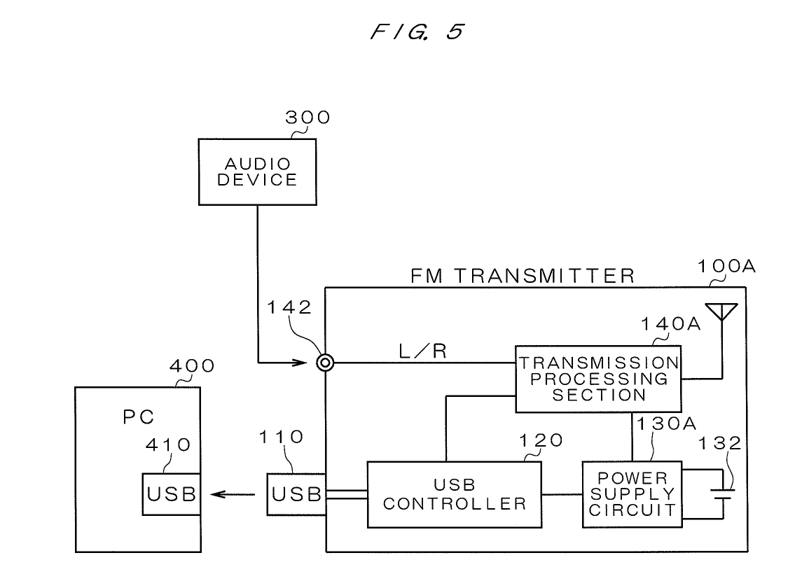

FIG. 5 is a view showing a configuration of an FM transmitter of a second embodiment. The FM transmitter 100A shown in FIG. 5 is constituted by including an USB plug 110, an USB controller 120, a power supply circuit 130A, a secondary battery 132, a transmission processing section 140A, and an external input terminal 142. This transmitter 100A has a configuration in which the secondary battery 132 and the external input terminal 142 are added to the transmitter 100 shown in FIG. 1, and at the same time, the power supply circuit 130 and the transmission processing section 140 are replaced by the power supply circuit 130A and the transmission processing section 140. Hereinafter, a description will be made, while paying attention to these different points.

The power supply circuit 130A, when the USB socket 410 of a PC 400 is connected with the USB plug 110, is connected to a power supply pin of the USB socket 410 and generates the predetermined operating voltage, and at the same time, performs charging for a secondary battery 132. Further, the power supply circuit 130A, when there is no feeding from the PC 400 through the USB socket 410 or the current necessary for the generation of the operating voltage is insufficient though feeding available, operates by the voltage applied from the secondary battery 132, and generates an operating voltage necessary for the operation of the transmission processing section 140A.

The transmission processing section 140A can be operated by the operating voltage fed by the power supply circuit 130A, and FM-modulates and transmits an audio signal outputted through the USB socket 410 of the PC 400 or an audio signal inputted through the external input terminal 142 (in the present embodiment, an analogue audio signal is assumed to be inputted). The external input terminal 142 can be connected with an external audio device 300, and analogue stereo signals (L signal and R signal) outputted from the audio device 300 are inputted to the external input terminal 142. The audio device 300 may be a cellular phone and the like in addition to a CD player, an MD (mini disk) player, an MP3 player, a radio receiver, and the like.

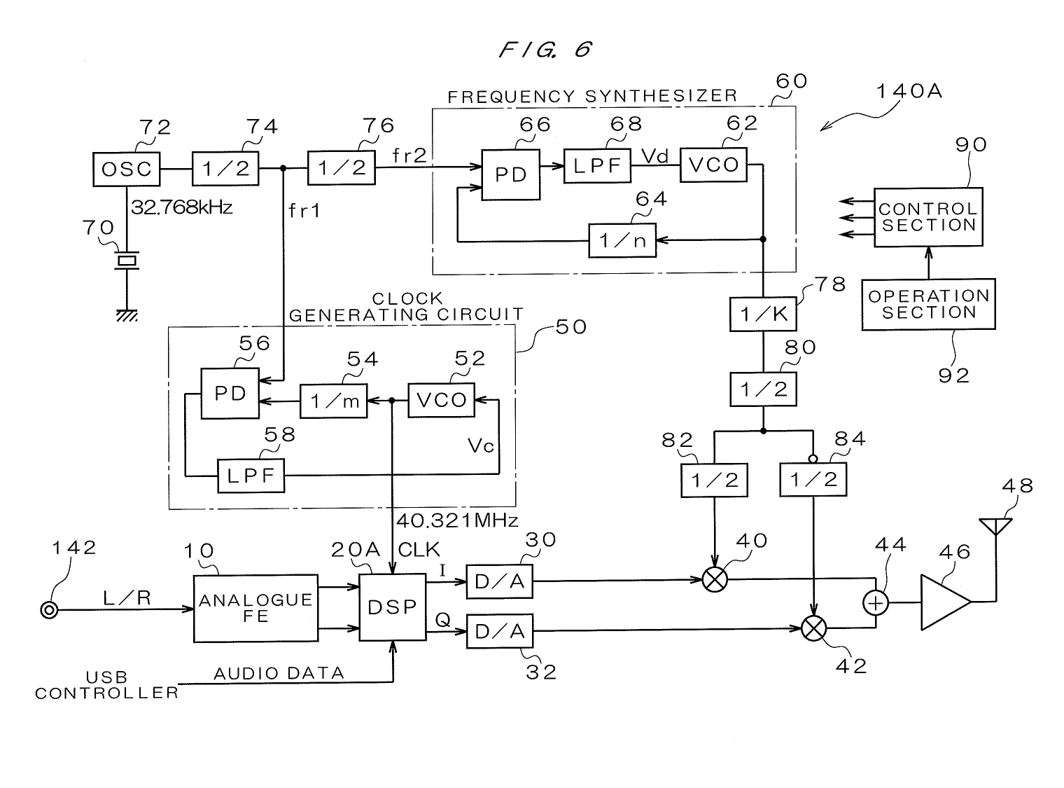

FIG. 6 is a view showing a detailed configuration of the transmission processing section 140A of the present embodiment. The transmission processing section 140A shown in FIG. 6 replaces the DSP 20 by a DSP 20A for the transmission processing section 140 shown in FIG. 2, and at the same time, adds an analogue front end (analogue FE) 10 at the preceding stage of the this DSP 20A.

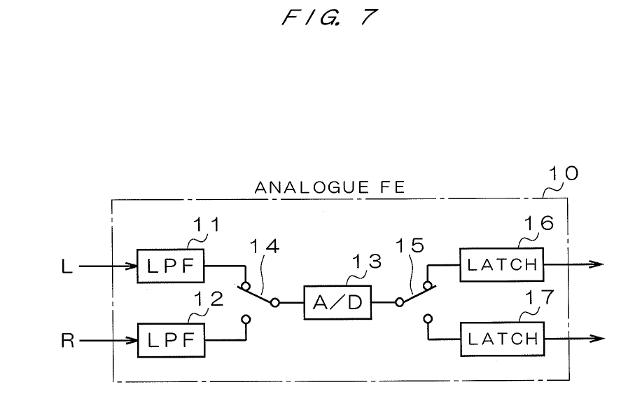

The analogue front end 10 is inputted with analogue stereo signals composed of the L signal and the R signal, and converts these signals into the L data and the R data as digital stereo data. FIG. 7 is a view showing a detailed configuration of the analogue front end 10. As shown in FIG. 7, the analogue front end 10 is provided with low pass filters (LPF) 11 and 12, an analogue-digital converter (A/D) 13, switches 14 and 15, and latches 16 and 17. The analogue L signal is inputted to the analogue-digital converter 13 through the switch 14 after going through the low pass filter 11. Similarly, the analogue R signal is inputted to the analogue-digital converter 13 through the switch 14 after going through the low pass filter 12. The analogue-digital converter 13 samples each of the inputted L signal and the R signal by a predetermined sampling frequency fs, thereby to generate digital L data and R data. The L data generated by the analogue-digital converter 13 is held in the latch 16 through the switch 15. Further, the R data generated by the analogue-digital converter 13 is held in the latch 17 through the switch 15. The two switches 14 and 15 are for synchronized switching over the input-output system of the analogue-digital converter 13, and switches over the connection destination at a frequency 2fs of two times the sampling frequency fs. When the low pass filter 11 inputted with the L signal and the analogue-digital converter 13 are connected by the switch 14, the analogue-digital converter 13 and the latch 16 for holding the L data are connected by the switch 15. On the other hand, when the low pass filter 12 inputted with the R signal and the analogue-digital converter 13 are connected by the switch 14, the analogue-digital converter 13 and the latch 17 for holding the R data are connected by the switch 15. From the analogue front end 10, the L data and the R data held in the latches 16 and 17 respectively are outputted to the DSP 20A of the next stage.

In the analogue front end 10, while the analogue-digital conversion processing has been performed for the L signal and the R signal by using one analogue-digital converter 13, two analogue-digital converters may be provided for these two kinds of signals, so that the analogue-digital conversion processing may be performed separately.

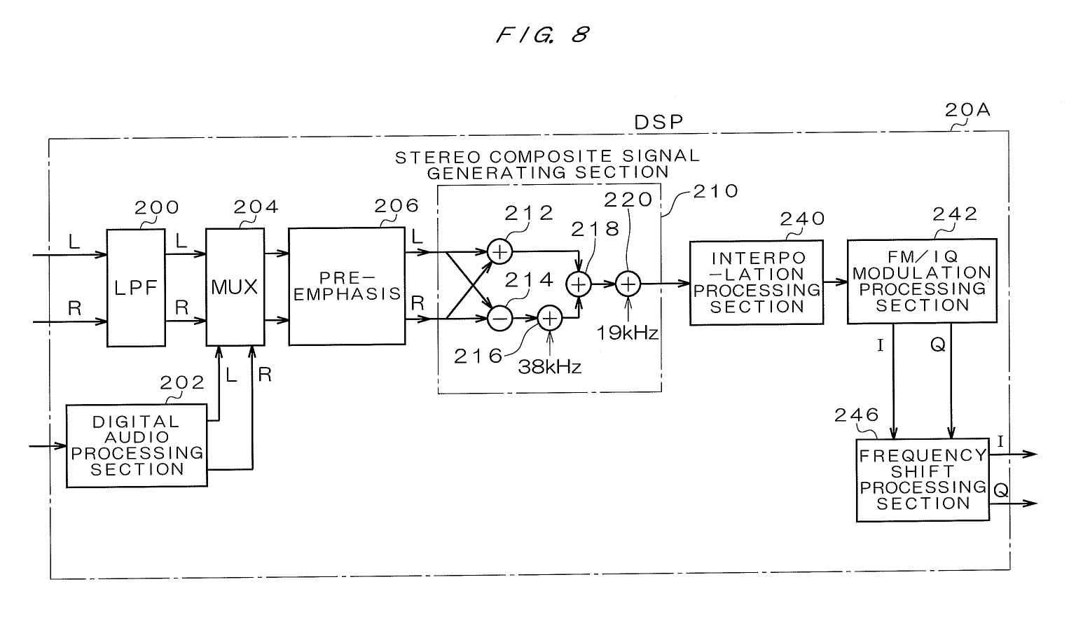

FIG. 8 is a view showing a detailed configuration of the DSP 20A of the present embodiment. This DSP 20A adds a low pass filter (LPF) 200 and a multiplexer (MUX) 204 to the DSP 20 shown in FIG. 4.

The low pass filter 200 performs a band limit for the prevention of overmodulation, and removes a high band component contained in each of the L data and the R data inputted from the analogue front end 10. The multiplexer 204 selects and outputs either of the L data and R data inputted through the low pass filter 200 or the L data and R data outputted from the digital audio processing section 202 (audio data outputted from the PC 400). With respect to a selecting method of the data, several patterns are conceivable. For example, when the USB plug 110 is inserted into the USB socket 410 of the PC 400 and the external input terminal 142 is prevented from using, and when the USB plug 110 is taken out from the USB socket 410 and the external terminal 142 can be used, the multiplexer 204 is inputted with either one only of the data outputted from the digital audio processing section 202 or the data outputted from the low pass filter 200, and therefore, the multiplexer 204 may select and output the inputted data only. Further, when there is a possibility that these two data are inputted simultaneously, either one of the input data may be selected by the multiplexer 204 in order of priority or according to the instructions of the user inputted by operating the operation section 92.

In this manner, the FM transmitter 100A of the present embodiment is provided with a secondary battery 132 connected to and charged by the power supply circuit 130A, and when the feeding from the PC 400 through the USB socket 410 is not available or the current necessary for the generation of the operating voltage is insufficient, the power supply circuit 130A is operated by the voltage applied from the secondary battery 132 and generates the operating voltage. As a result, it is possible to allow the FM transmitter 100A to separate from the PC and operate alone. Alternatively, even when connected to the PC 400 low in power supply feeding ability, the FM transmitter can perform a stable transmission operation.

Further, the FM transmitter is provided with an external input terminal 142 in addition to the USB plug 110, and the transmission processing section 140A can FM-modulate and transmit the audio signal inputted from the external input terminal 142. As a result, the charging of the secondary battery 132 is performed when the FM transmitter is connected to the PC 400, and when the connection is cut off, the output audio sound of another audio device 300 connected to the external input terminal 142 can be FM-modulated and transmitted. Further, at the time of charging the secondary battery 132, it has only to be connected to the PC 400 high in power supply capacity, so that the external power supply for charging and the cable for connecting to this external power supply are not required.

The present invention is not limited to the above described embodiment, and can be variously modified within the spirit of the invention. For example, in the above described embodiment, though the FM modulation processing and the IQ modulation processing have been performed in the DSP 20, only the generation of the stereo composite signal is performed in the DSP, and the FM modulation processing may be performed in the configuration disposed at the subsequent stage from the DSP.

Further, in the above described embodiment, though the PC 400 has been regarded as the USB host device, the USB host device other than the PC 400 may be connected with the FM transmitters 100 and 100A. For example, providing functionality as the USB host device for an audio device enables the audio device in which an FM-transmitter is not incorporated to FM-modulate and transmit the output audio sound in a simple manner.

Further, in the above described embodiment, though the quartz crystal resonator 70 having the natural oscillation frequency of 32.768 kHz has been used, the natural oscillation frequency of the quartz crystal resonator 70 is considered to have various modifications by the relationship with the reference frequency signals fr1 and fr2 and the assigned frequency interval of the FM broadcast waves. By considering these modifications, the relationship of the various frequencies in the applicable range of the present invention can be shown as follows.

(1) The case in which the frequency of the reference frequency signal fr2 does not match the assigned frequency interval of the FM broadcast waves or the integral fraction of this assigned frequency interval:

Although the assigned frequency interval of the FM broadcast waves is 100 kHz, considering that the output side of the frequency synthesizer 60 is connected with the frequency dividers 78, 80, 82, and 84 having “4K” in frequency dividing ratio of the whole, the interval of the oscillation frequency required for the frequency synthesizer 60 becomes (4K×100) kHz. Consequently, in the case (1), the frequency of the reference frequency signal fr2 does not match (4K×100) kHz or does not match the integral fraction of (4K×100) kHz. The frequency dividers 74 and 76 (the whole frequency dividing ratio is 4) are connected to the oscillator 72 at the subsequent stage, and after all, the case (1) means that the natural oscillation frequency of the quartz crystal resonator 70 does not match (4×4K×100) kHz or does not match the integral fraction of (4×4K×100) kHz. For example, when K=1, the quartz crystal resonator 70 having the natural oscillation frequency not matching the value of 1600 kHz or the integral fraction of 1600 kHz is used. The natural oscillation frequency (32.768 kHz) of the quartz crystal resonator 70 shown in FIG. 2 is applied to the case (1).

Further, in the present embodiment, since the stereo modulation operation is performed by the digital processing by the DSP20, the signal of 19 kHz or 38 kHz is not required as heretofore, and as the condition of the natural oscillation frequency of the quartz crystal resonator 70, a condition that the frequency does not match the integral multiple of 19 kHz can be added. In other words, at the time of setting (selecting) the natural oscillation frequency of the quartz crystal resonator 70, the condition that the frequency matches the integral multiple of the 19 kHz is not required. As a result, a frequency condition required for the usable quartz crystal resonator can be further relaxed, thereby enabling a degree of freedom for part selection to be improved.

(2) The case in which the reference frequency signal fr2 matches the assigned frequency interval of the FM broadcast waves or the integral fraction of this assigned frequency interval:

Contrary to the case (1), the reference frequency signal fr2 may be allowed to match the frequency assigned interval of the FM broadcast waves or an integral fraction of this frequency assigned interval. That is, the natural oscillation frequency of the quartz crystal resonator 70 may be allowed to match (4×4K×100) kHz or an integral fraction of (4×4K×100) kHz. As a result, the FM modulation signal having no frequency error can be generated and transmitted for receivable frequency, and a reception quality at the time of receiving the FM modulation signal by the FM receiver can be improved.

Further, in the above described embodiment, though the signal which is frequency-divided the output signal of the oscillator 72 by the frequency divider 74 has been inputted to a clock generating circuit 50 as a first reference frequency signal fr1, and at the same time, the signal which is frequency-divided the output signal of the oscillator 72 by the frequency dividers 74 and 76 has been inputted to the frequency synthesizer 60 as the second reference frequency signal fr2, the output signal of the oscillator 72 may be used as either one of the first and second reference frequency signals fr1 and fr2 without passing through the frequency divider.

Further, in the above described second embodiment, though the analogue audio signal has been inputted to the external input terminal 142, the digital audio data outputted from the external audio device 300 may be inputted to the external input terminal 142. In this case, the analogue front end 10 shown in FIG. 6 is not required, and the inputted audio data may be directly inputted to the DSP 20A.

### INDUSTRIAL APPLICABILITY

According to the present invention, the connection of the FM transmitter is facilitated because it can be connected only by inserting the USB plug into the USB connector. Further, when connected, the FM transmitter is recognized as an USB device sound source similarly to an USB speaker or an USB-connected audio device and the like, and audio data is inputted in the isochronous transfer and is FM-modulated and transmitted, thereby eliminating the troublesome operation after the connection. Particularly, when the FM transmitter is connected to the USB connector, the power supply circuit operates and the FM transmitter is ready for transmission. This eliminates a power switch, thereby making the operation simple. Further, the USB host device can recognize the FM transmitter as an USB device sound source, similarly to the USB speaker and the like, and has only to output the audio data, and therefore, installation of a special driver for the FM transmitter is not required, and this eliminates the special operation accompanied with the connection.

1. An FM transmitter having an USB device function connectable to an USB host device, comprising:
a power supply circuit connected to a power supply pin of an USB socket of said USB host device and adapted to generate a predetermined operating voltage when an USB plug is connected to said USB socket;
an USB controller adapted to make a request that its own apparatus being a device audio source inputs/outputs data by isochronous transfer in a configuration performed by said USB host device, and
a transmission processing section enabled by an operating voltage supplied from said power supply circuit and adapted to FM-modulate and output audio data outputted from said USB host device through said USB socket.

2. The FM transmitter according to claim 1, wherein said USB host device to which said USB plug is connected is a personal computer.

3. The FM transmitter according to claim 1, wherein a CMOS process or MOS process is used to form structures corresponding to said power supply circuit, said USB controller, and said transmission processing section on a semiconductor substrate.

4. The FM transmitter according to claim 1, comprising a secondary battery connected to and charged by said power supply circuit,
wherein when said power supply circuit is not fed from said USB host device through said USB socket, said power supply circuit is operated by voltage applied from said secondary battery to generate said operating voltage.

5. The FM transmitter according to claim 4, comprising an external input terminal in addition to said USB plug,
wherein said transmission processing section FM-modulates and transmits an audio signal inputted from said external input terminal.

6. The FM transmitter according to claim 1, comprising a secondary battery connected to and charged by said power supply circuit,
wherein when current required for generation of said operating voltage is insufficient in feeding from said USB host device through said USB socket, said power supply circuit is operated by voltage applied from said secondary battery to generate said operating voltage.
